(19) United States
(12) Patent Application Publication
(10) Pub. No.: US 2010/0076717 A1
(43) Pub. Date: Mar. 25, 2010

(54) Control and programming apparatus for processing tool data record of three-dimensional tool model

(75) Inventors: Felix Thiel, Heilbronn (DE); Christian Pfau, Freiberg/Neckar (DE)

Correspondence Address: POSZ LAW GROUP, PLC, 12040 SOUTH LAKES DRIVE, SUITE 101, RESTON, VA, 20191, US

(73) Assignee: E. Zoller GmbH & Co., KG Einstell- und Messgerate, Pleidelsheim (DE)

(21) Appl. No.: 12/379,075

(22) Filed: Feb. 12, 2009

(30) Foreign Application Priority Data
Sep. 24, 2008 (DE) 10 2008 048 776.7

(51) Int. Cl. G06F 19/00

(52) U.S. Cl. 702/123

(57) ABSTRACT

A control and programming apparatus, in particular a measuring device control and/or programming apparatus, is provided for controlling and/or programming a measurement sequence for a tool. The control apparatus has a data processing unit having a data input unit provided for receiving and/or reading in a desired tool data record for the measurement sequence.

### CROSS REFERENCE TO RELATED APPLICATION

The present application is related to, and claims priority from, German patent application no. DE 10 2008 048 776.7, filed on Sep. 24, 2008, the contents of which are incorporated by reference.

### BACKGROUND

The invention relates generally to control technology, and in particular to a control apparatus for controlling and/or programming a measurement sequence for a tool.

Control apparatuses, in particular measuring device control and programming apparatuses, provided for controlling and programming a measurement sequence for a tool, and having a data processing unit with a data input unit for receiving and reading in a desired tool data record for the measurement sequence, are well known.

However, one associated drawback of conventional control apparatuses is that the measurement sequence is often difficult to control in a simple manner.

### SUMMARY

Therefore, in view of the above associated drawback, the embodiments described below enable the measurement sequence to be controlled in a simple manner.

In particular, a measuring device control and programming apparatus is provided to control and program a measurement sequence for a tool. The apparatus includes a data processing unit having a data input unit for receiving and/or reading in a desired tool data record for the measurement sequence.

Preferably, the data processing unit is for receiving and/or reading in a desired tool data record of a three-dimensional tool model. As a result, the three-dimensional tool model can be used to program and control the measurement sequence, thus making it possible to control and program the measurement sequence in a simple manner. In particular, the three-dimensional tool model can be presented, thus making it possible to control and program the measurement sequence in a particularly simple manner. Furthermore, as a result of the fact that the three-dimensional tool model is input, a tool model which makes it possible to define the measurement sequence in a particularly accurate manner is available.

In this case, the term “provided” should be understood as meaning, in particular, specially equipped, designed and/or programmed. Furthermore, a “control unit” should be understood as meaning, in particular, a computation unit having a memory unit and an operating program which is stored in the memory unit and is specially programmed to control and/or regulate the measurement sequence in a measuring device, for example. A “programming unit” should be understood as meaning, in particular, a computation unit having a memory unit and an operating program which is stored in the memory unit and is specially provided for the purpose of programming the measurement sequence. “Programming” should be understood as meaning, in particular, the definition of measurement parameters for measurements. A “control and programming apparatus” should be understood as meaning, in particular, a computation unit which is provided for the purpose of control and programming. The control and programming apparatus may, in principle, also be in the form of an independent unit and may be arranged, for example, separately from the measuring device which is used to carry out the measurement sequence. For example, it is conceivable for the programming apparatus to be in the form of an office workstation device and for it to be provided for the purpose of interchanging data with the measuring device.

A “tool data record” should be understood as meaning, in particular, a data record which describes at least one shape of the tool at least in partial regions. A “desired tool data record” should be understood as meaning, in particular, a tool data record which describes a desired shape of the tool, which can differ from an actual shape of the tool. A “desired tool data record of a three-dimensional tool model” should be understood as meaning, in particular, a desired tool data record which describes the tool model of the tool in a three-dimensional space.

Furthermore, a “data processing unit” should be understood as meaning, in particular, a computation unit which is provided for the purpose of processing and, in particular, reappraising the desired tool data record for the measuring apparatus. In this case, “inputting” should be understood as meaning, in particular, electronic reception and/or reading in, for example reception via a network, a radio network and/or a cable network, or reading in from an electronic data storage medium, for example from a floppy disk or a USB data storage medium. In particular, the data processing unit is intended to be provided for the purpose of receiving and/or reading in an independent desired tool data record. A “desired tool data record which is independent of the control apparatus” should be understood as meaning, in particular, a desired tool data record which is created independently of the control apparatus, for example a desired tool data record created by a CAD apparatus.

In one refinement of the above embodiment, the data processing unit may be provided for the purpose of receiving and/or reading in at least one measurement parameter for the measurement sequence. As a result, the measurement sequence can also be at least partially defined independently of the control apparatus. As a result, during design of the tool, a tool manufacturer can predefine, for example, measurement parameters which are then measured when measuring the tool. In this case, a “measurement parameter” should be understood as meaning, in particular, a parameter which defines at least part of at least one measurement during the measurement sequence, for example a measurement position, an illuminance, a camera position and/or a camera field of view. A “measurement sequence” should be understood as meaning, in particular, a sequence of measurements, one measurement sequence being able to have one or more measurements in principle.

Also, the control and programming apparatus may have an input unit which is provided for a user input of at least one measurement parameter for the measurement sequence. As a result, the measurement sequence can be adapted using the control and programming apparatus.

Further, the control and programming apparatus may have a measurement sequence determining unit which is provided for the purpose of determining the measurement sequence in an at least partially independent manner. An advantageous measurement sequence can be determined as a result. In addition, it is possible to dispense with complicated input of the measurement profile. In this case, “determining” should be understood as meaning, in particular, calculating and/or ascertaining.

The measurement sequence determining unit is advantageously provided for the purpose of independently determining at least one measurement parameter for the measurement sequence. Input for the measurement sequence can be simplified further as a result.

Further, the measurement sequence determining unit may be provided for determining the measurement sequence using the desired tool data record. The measurement sequence can be determined in a particularly accurate manner as a result. The measurement sequence determining unit is also provided for determining the measurement parameter using the desired tool data record.

In addition, the control and programming apparatus may have an evaluation unit for at least partially comparing the desired tool data record with an actual tool data record. As a result, it is possible to dispense with an additional apparatus for comparing the desired tool data record with the actual tool data record.

In another alternative, the control and programming apparatus may have a display unit for simultaneously displaying at least part of the desired tool data record and at least part of the actual tool data record. As a result, the control and programming apparatus can be used in a particularly flexible manner.

Also, the data processing unit may be provided for the purpose of providing an actual tool data record for further processing. As a result, the actual tool data record is advantageously available for further operations with respect to the tool.

The data processing unit may also have a data output unit for sending and/or writing an actual tool data record of a three-dimensional tool model. As a result, the actual tool data record can be forwarded in a particularly simple manner. In this case, “sending and/or writing” should be understood as meaning, in particular, electronic sending and/or writing, for example sending via a network, a radio network and/or a cable network, or writing to an electronic data storage medium, for example to a floppy disk or a USB data storage medium.

According to one particularly advantageous refinement, a programming apparatus may be provided at least for the purpose of programming a measurement sequence for a tool and having a data processing unit for the measurement sequence. The data processing unit is provided for processing a desired tool data record of a three-dimensional tool model in order to program the measurement sequence. This makes it possible to program the measurement sequence in a particularly simple manner. In particular, it is advantageous if the programming apparatus is provided for the purpose of being arranged separately from the measuring device.

### BRIEF DESCRIPTION OF THE DRAWINGS

The drawing illustrates one exemplary embodiment of the invention. The drawing, the description and the claims contain numerous features in combination. A person skilled in the art would appreciate the features individually and further combinations.

FIG. 1 shows a measuring and setting device having a control and programming apparatus.

### DETAILED DESCRIPTION

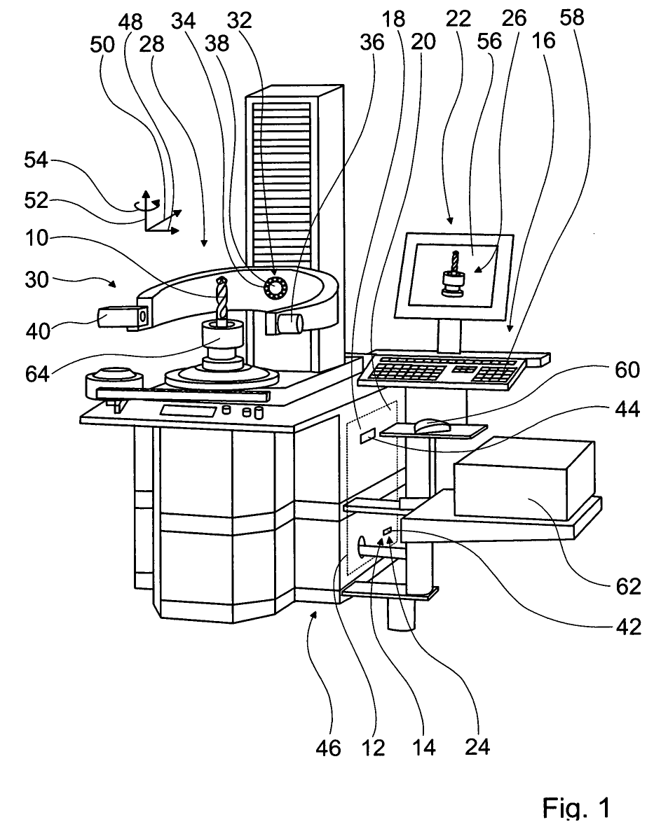

FIG. 1 shows a measuring and setting device for measuring a tool 10 and for setting a tool position in a tool holder 64. The measuring and setting device has a measuring apparatus 28 which is used to carry out the measurement sequence. For the measurement sequence, the measuring apparatus 28 has a camera apparatus 30 and an illumination apparatus 32. The camera apparatus 30 and the illumination apparatus 32 can be automatically moved by means of CNC axes. For the measurement sequence, the measuring apparatus 28 can move the camera apparatus 30 and the illumination apparatus 32 along the CNC axes in a fully automatic manner, as a result of which the measuring apparatus 28 can carry out the measurement sequence in an at least partially independent manner.

The illumination apparatus 32 has two illumination units 34, 36 which can be used to illuminate the tool 10 with illuminances which can be set. The camera apparatus 30 has two camera units 38, 40 which are designed for different measurement methods. The first camera unit 38 is intended for a front illumination method. It is essentially arranged on the same side of the tool 10 as the illumination unit 34. The second camera unit 40 is intended for a transmitted light method. It is essentially arranged opposite the illumination unit 36 with respect to the tool 10.

The measuring and setting device also has a control and programming apparatus 46 which is in the form of a measuring device control and/or programming apparatus for controlling a measurement sequence for the tool 10. The control and programming apparatus 46 is connected to the measuring apparatus 28. The control and programming apparatus 46 is used to control the measurement sequence carried out using the measuring apparatus 28. In addition, the measurement sequence can be programmed using the control and programming apparatus 46. The control and programming apparatus 46 is directly connected to the measuring and setting device. In principle, however, it may be remote from the measuring and setting device and may be in the form of a workstation apparatus, for example.

The control and programming apparatus 46 has a data processing unit 12 which can be used to receive a desired tool data record for the measurement sequence and to read in said data record in electronic form. In this case, the data processing unit 12 may receive or read in and process a desired data record for a two-dimensional tool model and a desired tool data record for a three-dimensional tool model 26. The desired tool data record which has been received or read in and processed is used to program the measurement sequence and to control the measurement sequence. The processed desired tool data record is used to present the tool model 26, in particular for the purpose of programming the measurement sequence.

In order to transmit the tool data record, the control and programming apparatus 46 has a data receiving and data reading unit 14 which can be used to transmit the tool data record to the control and programming apparatus 46 on different transmission paths. The data receiving and data reading unit 14 has a network means 42 which is used to connect the control and programming apparatus 46 to a network which can be used to receive the tool data. The data receiving and data reading unit 14 also has a data storage medium reader 44 which can be used to read different data storage media. The data storage medium reader 44 has a USB connection for reading USB data storage media. The data storage medium reader 44 also has an RFID reader which can be used to read RFID data storage media. In this case, the RFID reader can also be used to read RFID data storage media which are connected to the tool, for example an RFID data storage medium which is fitted to the tool holder 64 for the tool 10.

After it has been received or read in using the data receiving and data reading unit 14 of the data processing unit 12, the tool data record is in the form of a file which is evaluated by the data processing unit 12 of the control and programming apparatus 46. In this case, the data processing unit 12 can process different data formats, for example an ASCII format or different vector data formats.

The tool data record which has been received or read in by the data processing unit 12 contains all tool data relevant to the measurement sequence. The control and programming apparatus 46 determines the tool data relevant to the measurement sequence from the tool data record which has been received or read in by the data processing unit 12. A type of tool 10 to be measured is determined from the tool data record, for example. Desired dimensions for the tool 10 are also determined from the tool data record. In principle, yet other tool data may also be determined for the measurement sequence.

The tool data received or read in and processed using the data processing unit 12 describe a shape of the tool 10 at least in partial regions. In order to simplify the tool data record, predefined tool data may be used in this case, for example predefined basic forms, ratios of defined reference variables or other predefinable features. A basic form which is predefined in the control and programming apparatus 46 is a type of tool to be measured. The basic form can be used to specify a configuration of the tool 10 as a drill or a milling cutter, for example. Further predefined basic forms are a diameter, a number of cutting edges and a profile of cutting edges. In addition, fundamental tool data can be used for the tool 10, for example a description of the shape of the tool by specifying surface points. In principle, the tool 10 can also be described only by means of surface points.

In a desired tool data record for a three-dimensional tool model 26, the tool data at least partially have three values which describe the corresponding tool data in a space. Tool data which describe a surface point, for example, have a value for an x coordinate 48, a value for a y coordinate 50 and a value for a z coordinate 52. In principle, however, another coordinate system, for example an angle coordinate system with the x coordinate 48, the z coordinate 52 and an angle coordinate 54, may also be used. Tool data which describe a shape have, for example, a value for a height along the z coordinate 52, a value for a width along the y coordinate 50 and a value for a depth along the x coordinate 48. The profile of a cutting edge is also described using three values in a tool data record for a three-dimensional tool model 26.

The measurement sequence is used to determine an actual tool data record of a three-dimensional tool model 26, which data record exactly describes the tool 10 at least in partial regions, except for a measurement inaccuracy. For the measurement sequence, the control and programming apparatus 46 requires a measurement parameter set which defines measurements during the measurement sequence. The measurement parameter set has different measurement parameters. The measurement parameters define one or more measurements which are carried out during the measurement sequence. Measurement parameters which are used for the measurements are, for example, measurement points, settings for the camera apparatus 30, for example a selection of a measurement method, a viewing direction and/or a measurement window size, as well as settings for the illumination apparatus 32, for example illuminance and/or illumination direction.

The control and programming apparatus 46 has two operating modes for determining the measurement parameters for the measurement sequence. In a first operating mode, the measurement parameters are received or read in and processed using the data processing unit 12. In this case, the measurement parameters can be received or read in at the same time as the desired tool data record or in a temporally staggered manner with respect to the latter. In particular, the measurement parameters can be received or read in together with the tool data record in the form of a file. In principle, the control and programming apparatus 46 can use the data processing unit 12 to receive or read in a complete measurement parameter set or an individual measurement parameter or individual measurement parameters.

For a second operating mode, the control and programming apparatus 46 has an input unit 16 which can be used by a user to input an entire measurement data record or individual measurement parameters. The two operating modes can be used in a parallel manner in this case, that is to say the measurement data record may have both measurement parameters which have been received or read in and measurement parameters which have been input. The user can also use the input unit 16 to process the desired tool data record which has been received or read in.

The input unit 16 has a touch-sensitive screen 56. In order to input measurement parameters, the three-dimensional tool model 26 of the tool to be measured can be presented on the screen 56. In this case, the three-dimensional tool model 26 is displayed in a perspective presentation which can be adapted by the user using the input unit 16. The user can rotate, enlarge, reduce and move the presentation. Further input options for changing the presentation, for example an option for coloring the tool model 26 presented, are likewise possible in principle.

The measurement parameters can then be defined on the tool model 26 using the screen 56. The input unit 16 has a keyboard 58 which can be used to input numbers for defining the measurement parameters. In addition, the input unit 16 has a pointing device 60 which can likewise be used to input measurement parameters in conjunction with the screen 56, in particular. The pointing device 60 is in the form of a mouse. However, other pointing devices, for example a track ball, are also possible in principle.

If there is a complete measurement data record, the measurements in the measurement sequence have been defined and the control and programming apparatus 46 can carry out the measurement sequence. If the measurement data record is incomplete, for example because only individual measurement parameters have been received or read in, the control and programming apparatus 46 independently determines further measurement parameters which are required for the measurement sequence and thus independently completes the measurement data record.

The control and programming apparatus 46 has a measurement sequence determining unit 18 for independently determining measurement parameters. The measurement sequence determining unit 18 determines the measurement parameters using the desired tool data record. If reception or reading in and input of measurement parameters are dispensed with, the measurement sequence determining unit 18 can also determine all measurement parameters for a complete measurement parameter set on the basis of the desired tool data record. In addition, the measurement sequence determining unit 18 can optimize a complete measurement parameter set by moving an individual measurement position, for example.

The measurement sequence which defines an order of the measurements and movement paths between the measurement points is likewise determined by the control and programming apparatus 46. The measurement sequence determining unit 18 calculates the measurement sequence on the basis of the desired tool data record. In addition, the measurement sequence determining unit 18 can adapt a measurement sequence, which is already present and is stored, for example, in the control and programming apparatus 46 for the type of tool 10, to the desired tool data record and can optimize it.

As soon as the tool data record and the measurement parameter set have been completely determined and the measurement sequence has been determined, the user can start the measurement sequence using a command input. In principle, it is also conceivable for the measurement sequence to be started automatically as soon as the tool data record and the measurement parameter set are complete. During the measurement sequence, the user can use the input unit 16 to intervene in the measurement sequence. In this case, the user can change measurement parameters during the measurement sequence and can thus change a part of the measurement sequence which is still pending, for example in order to adapt that part of the measurement sequence which is still pending to the measurement sequence which has already been carried out.

After the measurement sequence has been concluded, the actual tool data or the actual tool data record determined from the measurement sequence is/are supplied to the data processing unit 12. The data processing unit 12 is used to provide the actual tool data record for further use, for example in order to remachine the tool 10.

The control and programming apparatus 46 has a data transmitting and data writing unit 24 in order to provide the actual tool data record. The data transmitting and data writing unit 24 is configured in a similar manner to the data receiving and data reading unit 14. The data transmitting and data writing unit 24 and the data receiving and data reading unit 14 are partially integral. The data transmitting and data writing unit 24 is intended, in particular, for the same transmission paths as the data receiving and data reading unit 14. The data transmitting and data writing unit 24 is used to provide the actual tool data record in the same format or on the same data storage medium as the desired tool data record was received or read in. In addition, the measurement parameter set which is used for the measurement sequence can also be provided at the same time as the actual tool data record, thus making it possible for the measurement sequence to be used further together with the actual tool data record, for example for a new measurement sequence following remachining of the tool 10.

The control and programming apparatus also has a display unit 22 for displaying the actual tool data record. Part of the display unit 22 is in the form of the screen 56 of the input unit 16. In addition, the display unit 22 has a printer unit 62. In this case, the actual tool data record can be presented both in the form of a graphical image of the tool 10 and in the numerical form of the actual tool data or selected actual tool data. In principle, it is also possible for only part of the tool 10 or the actual tool data to be presented. The display unit 22 automatically determines a selection of the actual tool data to be presented and a form of presentation. In addition, the user can select or adapt the actual tool data to be presented and the form of presentation.

In order to evaluate the actual tool data record, the control and programming apparatus 46 has an evaluation unit 20 which is used to evaluate the actual tool data and compare them with the desired tool data. The evaluation unit 20 is connected to the display unit 22 in order to present the actual tool data. The evaluation unit 20 uses the display unit 22 to simultaneously present the actual tool data and the desired tool data.

For differences between the actual tool data record and the desired tool data record, the evaluation unit 20 stores parameters which can be used by the display unit 22 to graphically present the differences between the actual tool data record and the desired tool data record. In this case, the parameters are in the form of color parameters which are used to present the differences on a color scale. An exemplary presentation is a single-color presentation of the tool model 26 resulting from the desired tool data record, whereas surface profiles of the tool model 26 resulting from the actual tool data record are presented in color. Overlaps and undercuts of the tool model 26 resulting from the actual tool data record with respect to the tool model 26 resulting from the desired tool data record are presented using different colors.

The presentation of the actual tool data, of the desired tool data and the presentation of the differences between the actual tool data and the desired tool data can be set using the input unit 16. The input unit 16 makes it possible to set a magnification factor, a section and/or coloring for the presentation of the tool 10. In addition, a selection for the actual tool data to be displayed and for the desired tool data to be displayed can be set.

In addition, the measurement sequence can be simulated using the control and programming apparatus. In order to simulate the measurement sequence, the control and programming apparatus uses the desired tool data record which has been received or read in. In order to perform the simulation, kinematics of the measuring device are stored in the control and programming apparatus. Possible operating states for the illumination apparatus 32 and the camera apparatus 30 are also stored in the control and programming apparatus. The control and programming apparatus uses the simulation to check that the measurement sequence can be carried out. In particular, a check is carried out in this case in order to determine whether the measurement sequence can be carried out without collision and whether the measurement parameters determined for the illumination apparatus 32 and the camera apparatus 30 are plausible and whether the intended measurements can be carried out using the measurement parameters which have been determined.

1. A control and programming apparatus for controlling a measurement sequence for a tool, comprising:
a data processing unit having a data input configured to reading a desired tool data record for the measurement sequence, wherein
the data processing unit is configured to read a desired tool data record of a three-dimensional tool model.

2. The control and programming apparatus as recited in claim 1, wherein
the data processing unit is configured to read at least one measurement parameter for the measurement sequence.

3. The control and programming apparatus as recited in claim 1, further comprising:
an input unit configured to receive a user input of at least one measurement parameter for the measurement sequence.

4. The control and programming apparatus as recited in claim 1, further comprising:
a measurement sequence determining unit configured to determine the measurement sequence in an at least partially independent manner.

5. The control and programming apparatus as recited in claim 4, wherein
the measurement sequence determining unit is configured to independently determine at least one measurement parameter for the measurement sequence.

6. The control and programming apparatus as recited in claim 5, wherein
the measurement sequence determining unit is configured to determine the measurement sequence using the desired tool data record.

7. The control and programming apparatus as recited in claim 1, further comprising:
an evaluation unit configured to at least partially compare the desired tool data record with an actual tool data record.

8. The control and programming apparatus as recited in claim 7, further comprising:
a display unit configured to simultaneously display at least part of the desired tool data record and at least part of the actual tool data record.

9. The control and programming apparatus as recited in claim 1, wherein
the data processing unit is configured to provide an actual tool data record for further processing.

10. The control and programming apparatus as recited in claim 1, wherein
the data processing unit has a data output unit configured to output an actual tool data record of a three-dimensional tool model.

11. A method for programming a measurement sequence for a tool, comprising:
receiving a desired tool data record of a three-dimensional tool model; and
processing the desired tool data record of the three-dimensional tool model in order to program the measurement sequence.

12. A programming apparatus for programming a measurement sequence for a tool, comprising:
a data processing unit for the measurement sequence, wherein
the data processing unit is configured to process a desired tool data record of a three-dimensional tool model in order to program the measurement sequence.
